(19) United States
(12) Patent Application Publication
(10) Pub. No.: US 2024/0352178 A1
(43) Pub. Date: Oct. 24, 2024

(54) AQUEOUS POLYURETHANE DISPERSION

(71) Applicant: Allnex Austria GmbH, WERNDORF (AT)

(72) Inventors: Robert HARRER, Graz (AT); Andreas J. STEINER, Graz (AT)

(73) Assignee: Allnex Austria GmbH, WERNDORF (AT)

(21) Appl. No.: 18/577,430

(22) PCT Filed: Jul. 19, 2022
(86) PCT No.: PCT/EP2022/070164

§ 371 Date: Jan. 8, 2024

(30) Foreign Application Priority Data
Jul. 30, 2021 (EP) 21188667.6

(51) Int. Cl. C08G 18/08; C08G 18/10; C08G 18/32; C08G 18/34; C08G 18/42; C08K 5/25; C09D 7/63; C09D 175/06

(52) U.S. Cl. CPC C08G 18/0866; C08G 18/0823; C08G 18/10; C08G 18/3206; C08G 18/348; C08G 18/4252; C08K 5/25; C09D 7/63; C09D 175/06; C08G 2150/00

(57) ABSTRACT

The present invention relates to an aqueous polyurethane dispersion comprising: a polyurethane A having pendant acid salt groups and end-standing carbonyl groups, and optionally a multifunctional compound B having functional groups reactable with the carbonyl groups of polyurethane A. The present invention further relates to a method for producing said aqueous polyurethane dispersion and to a coating comprising said aqueous polyurethane dispersion.

### FIELD OF THE INVENTION

The present invention relates to aqueous polyurethane dispersions of a polyurethane comprising carbonyl groups and optionally a multifunctional compound having functional groups reactable with the polyurethane carbonyl groups. The present invention also relates to a method for the preparation of said aqueous dispersions and to water borne coating formulations prepared from said dispersions, for application and curing on a broad range of substrates.

### BACKGROUND ART

Aqueous polyurethane have been known in the art.

WO 2006086322 (A1) and US 2006264568 (A1) disclose an aqueous dispersion of polyurethane comprising:
a) a urethane polymer of at least 2000 Dalton number average molecular weight;
b) a ketone functional molecule(s) having a number average molecular weight of less than 2000 Daltons having at least one ketone functional moiety;
c) at least one molecule of number average molecular of less than 2000 Daltons having at least one hydrazine moiety co-reactive with said ketone function moiety; and
d) water.

For the urethane polymer, comprising ketone functional moiety(s), said ketone functional moieties are incorporated in said polyurethane through reaction of a diisocyanate with the reaction product of levulinic acid and a diglycidylether of bisphenol A, thus implying a polyurethane comprising pendant ketone function.

EP 332326 (A2) discloses an aqueous selfcrosslinkable coating composition comprising an aqueous dispersion which comprises at least one polyurethane polymer, wherein said composition has hydrazine (or hydrazone) functional groups and carbonyl functional groups present in the composition to provide a selfcrosslinking reaction, in which said at least one polyurethane polymer takes part, via azomethine formation from the reaction of hydrazine (or hydrazone) functional groups and carbonyl functional groups during and/or after film formation from the aqueous composition.

U.S. Pat. No. 5,147,926 discloses a crosslinkable aqueous polyurethane dispersion having a long shelf life which comprises:
A) polyurethanes which have carbonyl groups, are dispersed in water in the presence of ammonia or of organic amines and are obtained by reacting
   a) organic polyisocyanates with
   b) compounds which contain one or more active hydrogen atoms and one or more salt groups or one or more groups capable of salt formation and
   c) carbonyl-containing mono-and/or polyalcohols, selected from hydroxyacetone, hydroxybenzaldehyde, acetoin, benzoin or a mixture, and
B) polyhydrazides.

In U.S. Pat. No. 5,147,926 suitable carbonyl-containing mono-and/or polyalcohols c) described are, for example, hydroxyacetone, hydroxybenzaldehyde, acetoin and benzoin. Adducts of diepoxides, such as 2,2-bis-(4-hydroxyphenyl)-propane (bisphenol A) and ketocarboxylic acids, such as pyruvic acid and levulinic acid, are also described as suitable. Other suitable components c) described are ketocarboxylates which are obtainable by partial esterification of ketocarboxylic acids with polyalcohols or by partial transesterification of ketocarboxylates with polyalcohols (partial esters). These esters also have one or more, preferably two, hydroxyl groups.

DE 196 47 982 A1 discloses an aqueous dispersion which comprises a polyurethane polymer with structural units containing keto-and amide groups. For example, N-(2-hydroxyethyl) acetoacetamide is described to react in MEK with
a) polyester polyol made of adipic acid, isophthalic acid and 1,6-hexandiol,
b) dimethylolpropionic acid,
c) 1,4-butandiol, and
d) isophorondiisocyanate.
   The so formed polyurethane prepolymer was neutralized with triethylamine, dispersed in water and subsequently diethylentriamine added to the dispersion. After removal of process solvent the dispersion had a solids content of 34,9% and a pH value of 7,6.

### AIM OF THE INVENTION

The present invention aims to provide an aqueous dispersion for coating compositions that do not present the limitations of the prior art.

It is the aim of the present invention to provide an aqueous polyurethane-dispersion with an enhanced solubility and re-solubility compared to the current state in the art systems.

It is a further aim of the present invention to provide aqueous polyurethane dispersions for use in a coating formulation, being part of a multilayer system with improved intercoat adhesion.

### SUMMARY OF THE INVENTION

The present invention discloses an aqueous polyurethane dispersion comprising:
a polyurethane A having pendant acid salt groups and end-standing carbonyl groups, and
optionally a multifunctional compound B having functional groups reactable with the carbonyl groups of polyurethane A,
   wherein
   said polyurethane A, in its solid unneutralized form, is characterized by:
a weight average molecular weight comprised between 3,000 and 30,000 g/mol, as measured by GPC in tetrahydrofuran calibrated with polystyrene standards;
a carbonyl content of more than 150 mmole/kg; and said polyurethane A is the reaction product of:
an isocyanate functional polyurethane prepolymer A1 comprising acid groups; and
from 50 to 100 moles of a carbonyl functional building block A2, for 100 isocyanate equivalents of the isocyanate functional polyurethane prepolymer A1, said carbonyl functional building block A2 being the reaction product of an alpha, beta ethylenically unsaturated group comprising compound comprising a carbonyl group A21 and a primary amine A22, said primary amine A22 being selected from the group consisting of alkylamines, alkanol amines and mixtures thereof; and
from 0 to 50 moles of a primary amine A22, for 100 isocyanate equivalents of the isocyanate functional polyurethane prepolymer A1, said primary amine A22 being selected from the group consisting of alkylamines, alkanol amines and mixtures thereof; and
one or more acid neutralizing compound(s) N;
wherein
   said carbonyl functional building block A2 comprises secondary amine groups of the formula R1-NH-R2, wherein R1 is an alkyl or an hydroxyalkyl moiety and wherein R2 is a molecular entity comprising a carbonyl group;
   said carbonyl functional building block A2 is bound to the isocyanate functional polyurethane prepolymer A1 by means of an urea linkage;
   said carbonyl functional building block A2 is bound at the extremity of the isocyanate functional polyurethane prepolymer A1.

Preferred embodiments of the present invention disclose one or more of the following features:
polyurethane A, in its solid unneutralized form, is characterized either
   by a hydroxyl content of 0 mmole/kg, for R1 being and alkyl group and optional additional alkylamine; or
   by a hydroxyl content of at least 250 mmole/kg, for R1 being an hydroxyalkyl group and optional additional alkanolamine; or
   by a hydroxyl content comprised between 0 mmole/kg and at least 250 mmole/kg, for R1 being a mixture of alkyl and hydroxyalkyl groups, and optional additional alkylamines, alkanolamines, or a mixture thereof;
the carbonyl groups of carbonyl functional building block A2 are of the ketone and/or aldehyde type;
the carbonyl functional building block A2 is the Michael addition reaction product of:
   an alpha, beta ethylenically unsaturated group comprising compound comprising a carbonyl group A21, said alpha, beta ethylenically unsaturated group comprising compound comprising a carbonyl group A21 being selected from the group consisting of acrolein, methacrolein, diacetone-acrylamide, crotonaldehyde, 4-vinylbenzaldehyde, vinyl alkyl ketones of 4 to 7 carbon atoms such as vinyl methyl ketone, and 10 acryloxy-and methacryloxy-alkyl propanols of formula CH₂═CHR³—C═O—O—CHR⁴—CR⁵R⁶—C═O—H, where R³ is H or methyl, R⁴ is H or alkyl of 1 to 3 carbon atoms, R⁵ is alkyl of 1 to 3 carbon atoms, and R⁶ is alkyl of 1 to 4 carbon atoms; and
   a primary amine A22 selected from the group consisting of C1-C6 alkylamines, C1-C6 alkanolamines and mixtures thereof;
the carbonyl functional building block A2 is the Michael addition reaction product of
   a primary amine A22 of the formula HO—(CH₂)n—NH₂ and/or H—(CH₂)n—NH₂, wherein n is an integer of from 1 to 6; and
   diacetone acrylamide A21;
the isocyanate functional polyurethane prepolymer A1 is the reaction product of:
   one or more polyisocyanate(s) I;
   one or more isocyanate reactive compound(s) IC having at least two isocyanate reactive groups selected from the group consisting of monomeric compounds ICM, polymeric compounds ICP and mixtures thereof; and
   one or more isocyanate-reactive monomer(s) ICMA having at least two isocyanate reactive groups and at least one acid group or group being able to form an acid when contacted with water;
wherein isocyanate groups of I are in stoichiometric excess of isocyanate reactive groups of IC and ICMA;
the (optional) multifunctional compound B comprises at least two hydrazide functional groups;
the (optional) multifunctional compound B is selected from the group consisting of oxalic acid dihydrazide, malonic acid dihydrazide, succinic acid dihydrazide, glutaric acid dihydrazide, adipic acid dihydrazide cyclohexane dicarboxylic acid dihydrazide, azelaic acid dihydrazide, and sebacic acid dihydrazide;
the mole ratio of the carbonyl functional groups of polyurethane A to the functional groups of multifunctional compound B is from 0.7 to 1.3.

The present invention further discloses a method for the preparation of the aqueous polyurethane dispersion comprising the steps of:
a. mixing one or more polymeric compound(s) ICP having at least two isocyanate reactive groups with one or more monomer(s) ICM having at least two isocyanate reactive groups in the presence of one or more isocyanate-reactive monomers ICMA having at least two isocyanate reactive groups and an acid group or group being able to form an acid when contacted with water, and heating the mixture to a temperature of at least 60° C. for at least 10 minutes under stirring;
b. continuously adding a sub-stoichiometric quantity of one or more multifunctional isocyanate(s) I to the mixture of step a), over a time period of from ten minutes to eighty minutes while keeping the temperature in a range of from 60° C. to 150° C., to form a hydroxyl-functional polyurethane prepolymer;
c. maintaining the reaction product op step b) at a temperature comprised between 120 and 135° C. for a time period of from 30 to 90 minutes, and subsequently cooling down to a temperature comprised between 60 and 100° C.;
d. adding, in one shot, a further amount of one or more multifunctional isocyanate(s) I, in stoichiometric excess, optionally in the presence of one or more compound(s) ICM and ICMA, to the hydroxyl-functional polyurethane prepolymer of step c) while stirring at a temperature of from 60° C. to 130° C., and continuing the reaction at a temperature of from 70 to 150° C. for at least one hour, to form an isocyanate-functional polyurethane prepolymer A1 with an isocyanate value corresponding to the theoretical one;
e. adding, in one shot, a mixture of compound A2, and optionally one or more primary amine(s) A22 and optionally water, to the isocyanate-functional polyurethane prepolymer A1 of step d) standing at a temperature comprised between 70 and 95° C., and homogenizing for at least 10 minutes at the resulting temperature, to convert the isocyanate-functional polyurethane prepolymer A1 into a polyurethane comprising end-standing carbonyl groups;
f. adding, in one shot, one or more neutralizing agent(s) N, in water, to the polyurethane of step e) comprising acid groups and carbonyl groups, and homogenizing for at least 10 minutes, to convert the acid groups into the corresponding salt, resulting in polyurethane A comprising pendant acid salt groups and end-standing carbonyl groups;
g. continuously adding deionized water, pre-warmed at a temperature comprised between 50 and 70° C., to the polyurethane A of step f), while vigorously stirring during at least 10 minutes and homogenizing for a further at least 20 minutes at a temperature comprised between 50 and 70° C., to form an aqueous dispersion of polyurethane A;
h. cooling down the aqueous dispersion of polyurethane A of step g) to a temperature below 40° C. and optionally adding multifunctional compound B;
i. adding deionized water to the aqueous dispersion of step h) comprising polyurethane A and optionally multifunctional compound B, to adjust the solid content to 40 +/−1% by weight.

Preferred embodiments of the method of the present invention disclose one or more of the following features:
the carbonyl functional building block A2, added in step e) is prepared by:
   heating A21 under nitrogen, at a temperature comprised between 50 and 80° C., until entirely molten;
   adding a 1 to 45 percentage molar excess of A22, in one shot; and
   heating the mixture of A21 and A22 to a temperature comprised between 60 and 85° C. for a period comprised between 1 and 24 hours, until full conversion of the ethylenically unsaturated bond, as confirmed by Fourier-transform infrared spectroscopy;
the one or more neutralizing agent(s) N, added in step f) is (are) selected from the group consisting of primary, secondary and tertiary amines and strong Arrhenius bases such as the hydroxides of alkali metals and alkaline earth alkali metals.

The present invention further discloses a coating composition comprising the aqueous polyurethane dispersion and one or more additives selected from the group consisting of organic solvents, defoamers, coalescing agents, flow modifiers, rheology additives, fillers, pigments, active pigments, dyes, wetting agents, emulsifiers, surfactants, thickeners, heat stabilizers, levelling agents, anti-cratering agents, sedimentation inhibitors, UV absorbers and antioxidants.

A preferred embodiment of the coating composition of the present invention provides a selfcrosslinking reaction via azomethine formation during and/or after film formation.

The present invention further discloses the use of the coating composition comprising the aqueous polyurethane dispersion, for coating a substrate selected from the group consisting of wood, engineered wood, metal, glass, cloth, composites, concrete, ceramics, leather, paper, plastics and foam.

### DETAILED DESCRIPTION OF THE INVENTION

It has been found that an aqueous polyurethane dispersion comprising:
a polyurethane A having pendant acid salt groups and end-standing carbonyl groups, and
optionally a multifunctional compound B having functional groups reactable with the carbonyl groups of polyurethane A;
   lead to coating compositions with enhanced solubility and re-solubility.

Preferably, the aqueous polyurethane dispersion comprises polyurethane A having pendant acid salt groups and end-standing carbonyl groups, and multifunctional compound B having functional groups reactable with the carbonyl groups of polyurethane A.

The polyurethane A of the present invention is the reaction product of an isocyanate functional polyurethane prepolymer A1 and carbonyl functional building block A2, or is the reaction product of an isocyanate functional polyurethane prepolymer A1 and a mixture comprising carbonyl functional building block A2 and one or more primary amines A22, said carbonyl functional building block A2 comprising secondary amine groups of the formula R¹—NH—R², wherein R¹ is an alkyl or an hydroxyalkyl moiety and wherein R² is a molecular entity comprising a carbonyl group.

The isocyanate functional polyurethane prepolymer A1 is the reaction product of an stoichiometric excess of one or more polyisocyanate(s) I, relative to the total of isocyanate reactive compounds IC.

The isocyanate reactive compounds IC, used in the present invention, preferably comprise at least two isocyanate reactive groups, and are selected from monomeric compounds ICM having at least two isocyanate reactive groups; polymeric compounds ICP having at least two isocyanate reactive groups; and monomeric compounds ICMA having at least two isocyanate reactive groups and an at least one acid group or an acid group precursor, and mixtures thereof.

The one or more polyisocyanate(s) I is (are) selected from the group consisting of aromatic or aliphatic or mixed aliphatic-aromatic isocyanates, and are preferably selected from the group consisting of trimethylene diisocyanate, tetramethylene diisocyanate, pentamethylene diisocyanate, hexamethylene diisocyanate (HDI), propylene diisocyanate, ethylethylene diisocyanate, 2,3-dimethylethylenediisocyanate, 1-methyltrimethylene diisocyanate, cyclopentylene 1,3-diisocyanate, cyclohexylene 1,4-diisocyanate, cyclohexylene 1,2-diisocyanate, phenylene 1,3-diisocyanate, phenylene 1,4-diisocyanate, 2,4-toluene diisocyanate, 2,6-toluene diisocyanate, biphenylene 4,4′-diisocyanate, bis-(4-isocyanatophenyl) methane (MDI), naphthylene 1,5-diisocyanate, naphthylene 1,4-diisocyanate, 1-isocyanatomethyl-5-isocyanato-1,3,3-tri-methylcyclohexane (IPDI), bis-(4-isocyanatocyclohexyl) methane (H12-MDI), 4,4′-diiso-cyanato-diphenyl ether, 2,3-bis-(8-isocyanatooctyl)-4-octyl-5-hexylcyclohexene, trimethylhexamethylene diisocyanates, 1,3-bis (2-isocyanatopropan-2-yl) benzene, meta-Tetramethylxylylene diisocyanate (TMXDI), uretdiones of the above diisocyanates, isocyanurates of the above diisocyanates and allophanates of the above diisocyanates and mixtures thereof.

Preferably the one or more polyisocyanates is (are) selected from the group consisting of 2,4-toluene diisocyanate, 2,6-toluene diisocyanate, 1,3-bis (2-isocyanatopropan-2-yl) benzene and mixtures thereof.

The one or more polyisocyanate(s) I can be obtained from petrochemical feedstock.

Alternatively and preferred, where possible, the polyisocyanates I are obtained from renewable feedstock. Particularly preferred is isophorone diisocyanate obtained from acetone. bio-based Other preferred polyisocyanates derived in part from renewable feedstocks are for example 1,5-pentamethylene diisocyanate, diisocyanates of the methyl or ethyl esters of I-lysine, isosorbide-based diisocyanates, furan based diisocyanate, bis (4-isocyanato-2-methoxyphenoxy) alkane, bis (4-isocyanato-2,6-dimethoxyphenoxy) alkane, 2,4-diisocyanato-1-pentadecylbenzene, di-and polyisocyanates based on fatty acids, dimer fatty acids and vegetable oils, 1-isocyanato-10-[(isocyanatomethyl)thio] decane and a product known under the tradename TOLONATE™ X FLO 100.

In yet another alternative, the one or more polyisocyanate(s) I is (are) obtained from petrochemical feedstock and/or renewable feedstock.

In the context of the present description, “renewable feedstock” refers to natural resources which will replenish to replace the portion depleted by usage and consumption, either through natural reproduction or other recurring processes (in a finite amount of time in a human time scale). Substances or mixtures of substances obtained from such renewable feedstock should have in total a bio-based carbon content of more than 20% by weight of total carbon content of the substance or mixture, the bio-carbon content being determined using the ASTM D6866-20 standard.

The monomeric compounds ICM having at least two isocyanate reactive groups preferably are monomeric compounds having at least two hydroxyl groups, or having at least two primary amino groups, or having at least one hydroxyl group and at least one primary amino group.

The monomeric compounds ICM having at least two isocyanate reactive groups can be obtained from petrochemical feedstock.

Preferably the monomeric compounds ICM having at least two hydroxyl groups are selected from the group consisting of 1,2-ethanediol, 1,2-and 1,3-propanediol, 1,2-and 1,4-butanediol, 2,2′-oxydi (ethan-1-ol), 2,2-dimethyl-1,3-propanediol, 2-methyl-2,4-pentanediol, 1,4-bis-hydroxymethylcyclohexane, 1,6-hexanediol, 1,8-octanediol, 1,10-decanediol, 1, 12-dodecanediol, 1, 13-tridecanediol, 1,18-octadecanediol, 1,21-heneicosanediol, 1,25-pentacosanediol, isosorbide, isomannide, isoidide and mixture thereof.

Alternatively and preferred, where possible, said monomeric compounds ICM having at least two hydroxyl groups (e.g. 1,3-propanediol, isosorbide, isomannide, isoidide) are obtained from renewable feedstock.

In yet another alternative, said monomeric compounds ICM having at least two hydroxyl groups are obtained from petrochemical feedstock and/or renewable feedstock.

Preferably the monomeric compounds ICM having at least two primary amino groups are selected from the group consisting of 1,4-diaminobutane, 1,6-diaminohexane, 2-methyl-1,5-diaminopentane and mixtures thereof.

Preferably the monomeric compounds ICM having at least one hydroxyl group and at least one primary amino group are selected from the group consisting of ethanolamine, propanolamine, 2-(2-amino-ethylamino-) ethanol and mixtures thereof.

The monomeric compound ICM may comprise a mixture of
one or more monomeric compounds having at least two hydroxyl groups and one or more monomeric compounds having at least two primary amino groups, or
one or more monomeric compounds having at least two hydroxyl groups and one or more compounds having at least one hydroxyl group and at least one primary amino group, or
one or more monomeric compounds having at least two primary amino groups and one or more compounds having at least one hydroxyl group and at least one primary amino group, or
one or more monomeric compounds having at least two hydroxyl groups, one or more monomeric compounds having at least two primary amino groups and or more compounds having at least one hydroxyl group and at least one primary amino group.

Preferably the polymeric compounds ICP having at least two isocyanate reactive groups are polymeric compounds ICP having at least two hydroxyl groups.

Preferably the polymeric compounds ICP are characterized by an hydroxyl number comprised between 20 and 400 mg KOH/g, more preferably between 40 and 300 mg KOH/g, most preferably between 50 and 250 mg KOH/g.

The polymeric compounds ICP can be obtained from petrochemical feedstock.

Preferably the polymeric compounds ICP having at least two hydroxyl groups are selected from the group consisting of polyesters having at least two hydroxyl groups ICP1, polyethers having at least two hydroxyl groups ICP2, polycarbonates having at least two hydroxyl groups ICP3 and mixtures thereof.

The polyesters ICP1 having at least two hydroxyl groups preferably have two hydroxyl groups and are prepared from stoichiometric excess of one or more diols and one or more diacids,
said diols being preferably selected from the group consisting of 1,2-ethanediol, 1,2-and 1,3-propanediol, 1,2-and 1,4-butanediol, 2,2′-oxydi (ethan-1-ol), 2,2-dimethyl-1,3-propanediol, 2-methyl-2,4-pentanediol, 1,4-bis-hydroxymethylcyclo-hexane, 1,6-hexanediol, 1,8-octanediol, 1,10-decanediol, 1,12-dodecanediol, 1,13-tridecanediol, 1,18-octadecanediol, 1,21-heneicosanediol, 1,25-pentacosane diol, isosorbide, isomannide, isoidide and mixture thereof;
said diacids being preferably selected from the group consisting of malonic acid, succinic acid, glutaric acid, adipic acid, octanedioic acid, and also dimeric fatty acids having up to forty carbon atoms, isophthalic acid, terephthalic acid, naphthalene dicarboxylic acids and mixtures thereof.

Optionally one or more hydroxy-carboxylic acids, such as for example hydroxybenzoic acid, lactic acid, gamma-hydroxybutyric acid, delta-hydroxyvaleric acid, and epsilon-hydroxycaproic acid, in combination with one or more diols may be used for the preparation of the hydroxyl-functional polyesters ICP1.

Preferably the polyesters ICP1 are the condensation product of diacids selected from the group consisting of adipic acid, isophthalic acid and mixtures thereof and a stoichiometric excess of diols selected from the group consisting of 1,4 butanediol, 1,6-hexanediol, 2,2′-oxydi (ethan-1-ol), 2,2-dimethyl-1,3-propanediol and mixtures thereof, said polyesters being characterized by a hydroxyl number comprised between 20 and 400 mg KOH/g, preferably between 30 and 250 mg KOH/g, more preferably between 40 and 150 mg KOH/g and an acid number of less than 3 mg KOH/g, preferably less than 2 mg KOH/g, more preferably less than 1 mg KOH/g said acid number being residual and generated by end-standing unreacted acid functionalities.

Alternatively and preferred, where possible, said diols (e.g. 1,3-propanediol), diacids (e.g. succinic acid) or hydroxy-carboxylic acid(s) (e.g. lactic acid) used for the preparation of the polyesters ICP1, are obtained from renewable feedstock.

In yet another alternative, the polyesters ICP1 are obtained from petrochemical feedstock and/or renewable feedstock.

By hydroxyl-functional polyester ICP1 having two hydroxyl groups the present invention should be understood as a polyester having almost two hydroxyl groups and a negligible amount of carboxylic acid groups, since a 100% conversion is hardly to achieve.

The polyether ICP2 preferably are poly (oxyalkylene) glycols comprising between 2 and 6 alkylradicals, more preferably the polyethers are selected from the group consisting of poly (oxyethylene) glycol, poly (oxypropylene) glycol, poly (oxytetramethylene) glycol and mixtures thereof.

The polyether ICP2 having at least two hydroxyl groups include products obtained by the polymerisation of a cyclic oxide, for example ethylene oxide, propylene oxide or tetrahydrofuran or by the addition of one or more such oxides to polyfunctional initiators, for example water, ethylene glycol, propylene glycol, diethylene glycol, cyclohexane dimethanol, glycerol, trimethylolpropane, pentaerythritol or Bisphenol A. Especially useful polyethers include polyoxypropylene diols and triols, poly (oxyethylene-oxypropylene) diols and triols obtained by the simultaneous or sequential addition of ethylene and propylene oxides to appropriate initiators and polytetramethylene ether glycols obtained by the polymerisation of tetrahydrofuran. Amine-terminated polyetherpolyols may also be used.

Preferably the polyethers ICP2 are poly (oxyalkylene) glycols comprising between 2 and 4 alkylradicals, more preferably the polyethers are selected from the group consisting of poly (oxyethylene) glycol, poly (oxypropylene) glycol, poly (oxytetramethylene) glycol and mixtures thereof.

Alternatively and preferred, where possible, polyethers ICP2 are poly (oxyalkylene) glycols obtained from renewable feedstock, more preferably poly (oxyalkylene) glycols obtained from bio-based 1,3-propandiol.

In yet another alternative, the polyethers ICP2 are obtained from petrochemical feedstock and/or renewable feedstock.

The polycarbonate ICP3 compounds having at least two hydroxyl groups preferably are prepared by reaction of polyols, such as 1,3-propanediol, 1,4-butanediol, 1,6-hexanediol, diethylene glycol, triethylene glycol, 1,4-bishydroxymethylcyclohexane, 2,2-bis (4-hydroxycyclohexyl) propane, neopentylglycol, trimethylolpropane or pentaerythritol, with di-carbonates, such as dimethyl, diethyl or diphenyl carbonate, or phosgene.

Alternatively and preferred, where possible, the polycarbonate ICP3 compounds are obtained from renewable feedstock, more preferably polycarbonate compounds obtained from bio-based polyols (e.g. bio-based 1,3-propanediol or 1,5-pentanediol).

In yet another alternative, the polycarbonate ICP3 compounds are obtained from petrochemical feedstock and/or renewable feedstock.

Other polymeric compounds ICP, useful for the preparation of the isocyanate functional polyurethane prepolymer A1 of the present invention, include polyesteramides, polythioethers, polyacetals, polyolefins or polysiloxanes, said other compounds ICP having at least two hydroxyl groups.

The monomeric compounds ICMA having at least two isocyanate reactive groups and at least one acid group or acid group precursor, such as an anhydride, preferably are monomers having at least two hydroxyl groups and at least one acid group or acid group precursor. More preferably the one or more ICMA monomers are selected from the group consisting of 2,2-(bis-hydroxymethyl) acetic acid, 2,2-(bishydroxymethyl)-propionic acid, 2,2-(bishydroxymethyl) butyric acid and mixtures thereof.

The monomeric compounds ICMA having at least two isocyanate reactive groups and at least one acid group or acid group precursor, are, at a later stage of the polyurethane A preparation, converted into anionic dispersant groups, by converting the acid group into an acid salt group through the addition of one or more neutralizing compound(s) N.

The one or more neutralizing compound(s) N preferably are selected from the group consisting of primary, secondary and tertiary amines and strong Arrhenius bases such as the hydroxides of alkali metals and alkaline earth alkali metals.

More preferably the neutralizing compound(s) N are selected from the group consisting of ammonia, compounds having not more than one hydroxyl group and at least one tertiary amino group per molecule, and mixtures thereof.

Most preferably the neutralizing compound(s) N are selected from the group consisting of ammonia, trimethylamine, N,N-dimethylaminoethanol, 1-dimethylamino-2-propanol, 1-dimethylamino-3-propanol, 1-deoxy-1-(dimethylamino)-D-glucitol, N-(2-hydroxy ethyl) piperazine and mixtures thereof.

Carbonyl functional building block A2 comprises secondary amine groups of the formula R¹-NH-R², wherein R¹ is an alkyl or an hydroxyalkyl moiety, and wherein R² is a molecular entity comprising a carbonyl group, and is the reaction product of an alpha, beta ethylenically unsaturated group comprising compound comprising a carbonyl group A21 and a primary amine A22 selected from the group consisting of C1-C6 alkylamines, C1-C6 alkanolamines and mixtures thereof.

The primary alkylamine A22 is selected from the group consisting of methylamine, ethylamine, n-propylamine, iso-propylamine, n-butylamine, iso-butylamine, sec-butylamine, n-amylamine, iso-amylamine, n-hexylamine, 2-aminohexane, isohexylamine, 3,3-dimethyl-2-butanamine, 2-amino-4-methylpentane, 3,3-dimethylbutylamine, 3,3-dimethyl-2-butylamine, 1-amino-2-ethyl-n-butane, 3-amino-3-methylpentane and mixtures thereof.

Preferably the primary alkyl amine A22 is selected from the group consisting of one or more structures of the formula CH₃—(CH₂)n-NH₂ wherein n is an integer of from 1 to 5 (or of the formula H-(CH₂)n-NH₂ wherein n is an integer of from 1 to 6); more preferably the primary alkylamine A22 is butylamine.

The primary alkanolamine A22 is selected from the group consisting of methanolamine, ethanolamine, 3-amino-1-propanol, 3-amino-2-propanol, 1-amino-2-propanol, 4-amino-1-butanol, 3-amino-1-butanol, 2-amino-1-butanol, 2-amino-2-methyl-1 propanol, 5-amino-1-pentanol, 4-amino-1-pentanol, 3-amino-1-pentanol, 2-amino-1-pentanol, 5-amino-2-pentanol, 4-amino-2-pentanol, 3-amino-2-pentanol, 1-amino-3-pentanol 2-amino-3-pentanol, 4-amino-2-methyl-1-butanol, 4-amino-3-methyl-1-butanol, 2-amino-3-methyl-1-butanol, 4-amino-2-methyl-2-butanol, 3-amino-2,2-dimethyl-1-propanol, 6-amino-1-hexanol, 2-amino-1-hexanol, 3-amino-1-hexanol, 6-amino-3-hexanol, 2-amino-3-methylpentan-1-ol, and mixtures thereof.

Preferably the primary alkanolamine A22 is selected from the group consisting of one or more structures of the formula HO—(CH₂)n-NH₂ wherein n is an integer of from 1 to 6; more preferably the primary alkanolamine A22 is ethanolamine.

The alpha, beta ethylenically unsaturated group comprising compound comprising a carbonyl group A21 is selected from the group consisting of acrolein, methacrolein, diacetone-acrylamide, crotonaldehyde, 4-vinylbenzaldehyde, vinyl alkyl ketones of 4 to 7 carbon atoms (such as vinyl methyl ketone), and acryloxy-and methacryloxy-alkyl propanols of formula:

CH₂═CHR³—C═O—O—CHR⁴—CR⁵R⁶-C═O—R⁷,

where R³ is H or methyl, R⁴ is H or alkyl of 1 to 3 carbon atoms, R⁵ is alkyl of 1 to 3 carbon atoms, R⁶ is alkyl of 1 to 4 carbon atoms, R⁷ is H or alkyl of 1 to 3 carbon atoms.

Preferably the alpha, beta ethylenically unsaturated group comprising compound comprising a carbonyl group A21 is diacetone-acrylamide.

As known in the art, the reaction of the primary amine A22 with the alpha, beta ethylenically unsaturated group comprising compound comprising a carbonyl group A21 is a Michael addition reaction, wherein A22 is the Michael donor and A21 is the Michael acceptor.

The polyurethane A of the present invention is the reaction product of
the isocyanate functional polyurethane prepolymer A1 and
the secondary amines of carbonyl functional building blocks A2 and
the primary amines of optional compound A22,
   wherein carbonyl functional building blocks A2 and optional compounds A22 are bound to the isocyanate terminated polyurethane prepolymer A1 by means of an urea linkage.

Preferably polyurethane A is the reaction product of
the isocyanate functional polyurethane prepolymer A1, and
from 50 to 100 moles, preferably 70 to 99 moles, of secondary amines of carbonyl functional building block A2, and
from 0 to 50 moles, preferably from 1 to 30 moles, of primary amines of optional compound A22,
   for 100 isocyanate equivalents of the isocyanate functional polyurethane prepolymer A1.

Preferably the carbonyl group is of the ketone-or the aldehyde-type.

The carbonyl functional building block A2 is bound at the extremities of the isocyanate functional polyurethane prepolymer A1, resulting in polyurethane A comprising end-standing carbonyl groups.

The polyurethane A of the present invention is substantially free of pendant carbonyl groups, i.e. the polyurethane comprises less than 5%, preferably less than 4%, more preferably less than 3%, most preferably less than 2%, most preferably less than 1%, most preferably 0% of pendant carbonyl groups, relative to the total amount of carbonyl groups, wherein pendant carbonyl groups should be understood as carbonyl group comprising molecular entities, bound to the polyurethane at locations situated along the entire length of the polyurethane and not at the extremities of the polyurethane.

Preferably polyurethane A only comprises end-standing carbonyl groups and no pendant carbonyl groups.

Preferably polyurethane A comprises a carbonyl group at least at one of its extremities, more preferably polyurethane A comprises a carbonyl group at all its extremities. Most preferably polyurethane A is a linear polyurethane comprising carbonyl groups at both of its extremities.

Polyurethane A, in its solid unneutralized form, is characterized by a weight average molecular weight comprised between 3,000 and 30,000 g/mole, preferably between 5,000 and 20,000 g/mole, more preferably between 7,000 and 20,000 g/mole, most preferably between 7,000 and 15,000 g/mole.

Polyurethane A, in its solid unneutralized form, is characterized by a carbonyl content of more than 150 mmole/kg, preferably between 170 and 700 mmole/kg, more preferably between 200 and 700 mmole/kg, most preferably between 250 and 700 mmole/kg, or even between 300 and 700 mmole/kg.

Polyurethane A, in its solid unneutralized form, is characterized by:
by a hydroxyl content of 0 mmole/kg, for
   carbonyl functional building block A2 being the reaction product of an alpha, beta ethylenically unsaturated group comprising compound comprising a carbonyl group A21 and a C1-C6 primary alkylamine A22, and
   optional primary amine A22 being a C1-C6 primary alkylamine; or
by a hydroxyl content of at least 250 mmole/kg, preferably between 250 and 650 mmole/kg, more preferably between 350 and 550 mmole/kg, for
   carbonyl functional building block A2 being the reaction product of an alpha, beta ethylenically unsaturated group comprising compound comprising a carbonyl group A21 and a C1-C6 primary alkanolamine A22, and
   optional primary amine A22 being a C1-C6 primary alkanolamine; or
by a hydroxyl content comprised between 5 mmole/kg and at least 250 mmole/kg, preferably between 10 and 640 mmole/kg, more preferably between 20 and 530 mmole/kg, for
   carbonyl functional building block A2 being the reaction product of an alpha, beta ethylenically unsaturated group comprising compound comprising a carbonyl group A21 and a primary amine A22 comprising a mixture of C1-C6 primary alkylamine and C1-C6 primary alkanolamine and
   optional primary amine A22 being a mixture of C1-C6 alkylamines and C1-C6 alkanolamines.

Polyurethane A, in its solid unneutralized form, is characterized by an acid content between 300 and 700 mmole/kg, preferably between 350 and 650 mmole/kg, more preferably between 400 and 600 mmole/kg, most preferably between 450 and 550 mmole/kg, originating from the pendant acid groups of monomeric compounds ICMA.

By polyurethane A, in its solid unneutralized form, the present invention should be understood as:
unneutralized polyurethane A:
polyurethane A wherein the carboxylic acid groups or acid group precursors of monomeric compounds ICMA are not converted into anionic dispersant groups, by the addition of one or more neutralizing compounds N. In its unneutralized form polyurethane A comprises pendant acid groups or acid group precursors;
solid polyurethane A:
polyurethane A, wherein deionized water, added, together with the carbonyl functional building block A2, for the preparation of carbonyl terminated unneutralized polyurethane A, is not taken into account.

The multifunctional compound B having functional groups reactable with the carbonyl groups of polyurethane A include polyhydrazide and polyhydrazone. Examples of such polyhydrazides and polyhydrazones include:
dicarboxylic acid bishydrazides of formula:

H₂N—NH—C(O)-R⁸—C(O)—NH—NH₂ and
dicarboxylic acid bis-hydrazones of formula:

R⁹R¹⁰═N—NH—C(O)-R⁸-C(O)—NH—N═CR⁹R¹⁰

wherein R⁸ is a covalent bond or a polyalkylene (preferably polymethylene) or alicyclic group having from 1 to 34 carbon atoms or a divalent aromatic ring, and R⁹ and R¹⁰ are selected from the group consisting of H and (C₁ to C₆) alkyl and alicyclic groups. Examples of suitable dihydrazides include oxalic acid dihydrazide, malonic acid dihydrazide, succinic acid dihydrazide, glutaric acid dihydrazide, adipic acid dihydrazide, cyclohexane dicarboxylic acid dihydrazide, azelaic acid dihydrazide, and sebacic acid dihydrazide.

Other suitable compounds B are polyhydrazides of carbonic acid, e.g. carbonic acid dihydrazide and compounds of the general formula:

H₂N—NH—CO—(NH—NH—CO—)ₓ—NH—NH₂

where x is from 1 to 5, preferably from 1 to 3, and bis-semicarbazides, especially aliphatic and cycloaliphatic bis-semicarbazides of the general formula:

H₂N—NH—CO—NH—R¹¹-HN—CO—NH—NH₂

where-R¹¹-is a straight or branched aliphatic radical of 2 to 7 carbon atoms or a carbocyclic radical of 6 to 8 carbon atoms, e.g. o-, m- or p-phenylene or toluene or cyclohexylidene or methylcyclohexylidene.

Other suitable compounds B are polyhydrazides of aromatic polycarboxylic acids, e.g. the dihydrazides of phthalic acid, terephthalic acid and isophthalic acid, and the dihydrazides, the trihydrazide and the tetrahydrazide of pyromellitic acid.

Other suitable compounds B are trihydrazides, e.g. nitrilotriacetic acid trihydrazide, and tetrahydrazides, e.g. ethylenediaminetetraacetic acid tetrahydrazide.

Other suitable compounds B are dihydrazino-and trihydrazino-triazine, thiocarbohydrazide and N, N′-diaminoguanidine, as well as hydrazinopyridine derivatives of the type of 2-hydrazino-pyridine-5-carboxylic acid hydrazide, 3-chloro-2-hydrazinopyridine-5-carboxylic acid hydrazide, 6-chloro-2-hydrazinopyridine-4-carboxylic acid hydrazide and 2,5-dihydrazinopyridine-4-carboxylic acid, and bis-thiosemicarbazides as well as bis-hydrazines of alkylene-bis-acrylamides, dihydrazinoalkanes and dihydrazines of aromatic hydrocarbons, e.g. 1,4-dihydrazinobenzene, 1,3-dihydrazinobenzene and 2,3-dihydrazinonaphthalene.

Preferably the multifunctional compound B is adipic acid dihydrazide.

Preferably the aqueous polyurethane dispersion of the present invention comprises polyurethane A, having pendant acid salt groups and end- standing carbonyl functional groups, and multifunctional compound B, wherein the mole ratio of the carbonyl functional groups of polyurethane A to the (hydrazide) functional groups of multifunctional compound B is from 0.7 to 1.3, preferably from 0.8 to 1.2, more preferably from 0.9 to 1.1.

The aqueous dispersion comprising polyurethane A and multifunctional compound B is preferably characterized by:
a solid content comprised between 30 and 60% by weight;
a dynamic viscosity at 23° C. and 100 rpm, according to ISO 2555-1974, comprised between 50 and 5,000 mPa·s.;
a pH, according to DIN 19268, comprised between 7 and 8.5;
a Z-average particle size, according to ISO 22412, comprised between 20 and 150 nm.

The aqueous polyurethane dispersion is prepared is a multi-step process comprising the steps of:
a. mixing one or more polymeric compound(s) ICP having at least two isocyanate reactive groups with one or more monomer(s) ICM having at least two isocyanate reactive groups in the presence of one or more isocyanate-reactive monomers ICMA having at least two isocyanate reactive groups and an acid group or group being able to form an acid when contacted with water, and heating the mixture to a temperature of at least 60° C., preferably at least 80° C., more preferably at least 100° C., most preferably at least 120° C. for at least 10 minutes, preferably for at least 20 minutes, under stirring;
b. continuously adding a sub-stoichiometric quantity of one or more multifunctional isocyanate(s) I to the mixture of step a), over a time period of from 10 minutes to 80 minutes, preferably of from 20 minutes to 70 minutes; more preferably from 30 to 60 minutes while keeping the temperature in a range of from 60° C. to 150° C., preferably of from 80 to 140° C., more preferably of from 100 to 135° C. to form a hydroxyl-functional polyurethane prepolymer;
c. maintaining the reaction product of step b) at a temperature comprised between 120 and 135° C., preferably between 130 and 135° C. for a time period of from 30 to 90 minutes, preferably of from 40 to 80 minutes, more preferably of from 50 to 70 minutes, and subsequently cooling down to a temperature comprised between 60 and 100° C., preferably between 70 and 90° C.;
d. adding, in one shot, a further amount of one or more multifunctional isocyanate(s) I, in stoichiometric excess, optionally in the presence of one or more compound(s) ICM and ICMA, to the hydroxyl-functional polyurethane prepolymer of step c) while stirring at a temperature of from 60° C. to 130° C., preferably of from 70 to 90° C., and continuing the reaction at a temperature of from 70 to 150° C., preferably at a temperature of from 75 to 90° C. for at least one hour, preferably for a time period comprised between 1 and 3 hours, more preferably for a time period comprised between 1 and 2 hours, to form an isocyanate-functional polyurethane prepolymer A1 with an isocyanate value corresponding to the theoretical one (confirmed by titration);
e. adding, in one shot, a mixture of carbonyl functional building block A2, and optionally one or more primary amine(s) A22 and optionally water, to the isocyanate-functional polyurethane prepolymer A1 of step d) standing at a temperature comprised between 70 and 95° C., preferably between 75 and 90° C., and homogenizing for at least 10 minutes, preferably for at least 15 minutes, at the resulting temperature, to convert the isocyanate-functional polyurethane prepolymer A1 into a polyurethane comprising end-standing carbonyl groups;
f. adding, in one shot, one or more neutralizing agent(s) N, in water, to the polyurethane of step e) comprising acid groups and carbonyl groups and homogenizing for at least 10 minutes, preferably for at least 15 minutes, to convert the acid groups into the corresponding salt, resulting in polyurethane A;
g. continuously adding deionized water, pre-warmed at a temperature comprised between 50 and 70° C., preferably comprised between 55 and 65° C. to the polyurethane A of step f) while vigorously stirring during at least 10 minutes, preferably at least 15 minutes and homogenizing for a further at least 20 minutes, preferably for a further at least 30 minutes at a temperature comprised between 50 and 70° C., preferably between 55 and 65° C., to form an aqueous dispersion of polyurethane A;
h. cooling down the aqueous dispersion of polyurethane A of step g) to a temperature below 40° C., preferably below 30° C. and optionally adding multifunctional compound B;
i. adding deionized water to the aqueous dispersion of step h) comprising polyurethane A and optionally multifunctional compound B, to adjust the solid content to 40 +/-1% by weight.

Calculating theoretical isocyanate values, as well as the confirmation by titration thereof, is well known to the skilled person in the art and is of general practice.

The addition in one shot, in step d) to f), should be understood as an addition over a time period which is at least 50% less, preferably at least 60% less, more preferably at least 70% less, most preferably at least 80% less or even at least 90% less than the homogenization period of the final mixture.

Carbonyl functional building block A2, added in step e) is prepared in a separate reaction by
heating A21 under nitrogen, at a temperature comprised between 50 and 80° C., preferably between 60 and 70° C., until entirely molten;
adding a 1 to 45 percentage, preferably a 1 to 35 percentage molar excess of A22, in one shot; and
heating the mixture of A21 and A22 to a temperature comprised between 60 and 85° C., preferably between 65 and 80° C., for a period comprised between 1 and 24 hours, preferably between 1 and 15 hours until full conversion of the ethylenically unsaturated bond, as confirmed by Fourier-transform infrared spectroscopy (FTIR).

The addition in one shot of A22 to A21 should be understood as an addition over a time period which is at least 50% less, preferably at least 60% less, more preferably at least 70% less, most preferably at least 80% less or even at least 90% less than the homogenization period of the mixture of A22 and A21.

The aqueous dispersions of the present invention preferably are used in waterborne coating compositions, further comprising one or more additives selected from the group consisting of organic solvents, defoamers, coalescing agents, flow modifiers, rheology additives, fillers, pigments, active pigments, dyes, wetting agents, emulsifiers, surfactants, thickeners, heat stabilizers, levelling agents, anti-cratering agents, sedimentation inhibitors, UV absorbers and antioxidants.

Alternatively, the aqueous polyurethane dispersion of the invention can be used in waterborne adhesive compositions. More specifically, the waterborne adhesive composition can comprise the aqueous polyurethane dispersion and one or more additives selected from the group consisting of organic solvents, defoamers, coalescing agents, flow modifiers, rheology additives, fillers, pigments, active pigments, dyes, wetting agents, emulsifiers, surfactants, thickeners, heat stabilizers, levelling agents, anti-cratering agents, sedimentation inhibitors, UV absorbers and antioxidants.

The water borne coating composition of the present invention can be applied to a wide variety of substrates selected from the group consisting of wood, engineered wood, metal, glass, cloth, composites, concrete, ceramics, leather, paper, plastics and foam.

The water borne coating compositions may be applied to the substrate by any conventional method including brushing, flow coating, roll coating, draw-down, coil coating, curtain coating, immersion coating, dip coating, spray coating, vacuum coating and the like. In general the water borne coating compositions are applied at a

liquid coating thickness adapted for obtaining a dry film thickness comprised between 5 and 50 μm, preferably between 8 and 40 μm, more preferably between 10 and 30 μm, most preferably between 10 and 20 μm.

The water borne coating compositions provide a selfcrosslinking reaction via azomethine formation during and/or after film formation.

### EXAMPLES

The following illustrative examples are merely meant to exemplify the present invention but are not intended to limit or otherwise define the scope of the present invention.

### Example 1: Synthesis of Keto-Functional Building Block A2 via Michael Addition

In a reactor purged with nitrogen 150.00 g (0.8864 mole) solid diacetone acrylamide (A21) was charged and heated to 65° C. until the material was entirely molten. Then a slight molar excess of 72.19 g (1.1819 mole) of ethanolamine (A22) was added to the reactor in one shot and the resulting reaction mixture was stirred at 70° C. to 75° C. for 1 to 4 hours until full conversion of the double bond of diacetone acrylamide, confirmed by FTIR measurement. The reaction product was then cooled to ambient temperature and used as crude product without further purification in the synthesis of the carbonyl-terminated polyurethane. The keto-functional building block (A2) was characterized by a keto content of 3.9894 mmole/g, an amino content of 5.3193 mmole/g and a hydroxyl content of 5,3193 mmole/g.

### Example 2 and 3: Synthesis of Keto-Functional Building Block A2 via Michael Addition

In table 1 the compositions of the keto-functional building blocks A2, of Example 2 to 3 are reproduced. The keto-functional building blocks A2 of Example 2 and 3 were prepared according to the process of Example 1.

TABLE 1

| Components | Ex. 2 | Ex. 3 |
|---|---|---|
| Diacetone acrylamide | 150.00 g | 150.00 g |
| | (0.8864 mole) | (0.8864 mole) |
| Ethanolamine | 54.89 g | — |
| | (0.8987 mole) | |
| Butylamine | — | 86.40 g |
| | | (1.1819 mole) |
| Functionalities | | |
| Keto-content [mmole/g] | 4.3262 | 3.7496 |
| Amino-content [mmole/g] | 4.3863 | 4.9996 |
| Hydroxy-content [mmole/g] | 4.3863 | 0 |

### Example 4: Synthesis of Aqueous Dispersion Comprising Polyurethane A having Pendant Acid Salt Groups and Carbonyl End-Standing Groups, and Multifunctional Compound B

In a reactor purged with nitrogen 275.21 g (0.201 mole) of polyester diol (ICP) (consisting of 18.2% 1,6-hexane diol, 18.1% diethylene glycol, 11.5% neopentyl glycol, 18.4% isophthalic acid and 33.8% adipic acid), 0.15 g (0.0014 mole) of neopentyl glycol (ICM) and 31.33 g (0.2344 mole) of dimethylol propionic acid (ICMA) were filled, subsequently heated to 130° C. and homogenized at 130° C. for 30 minutes. Then 26.10 g (0.1499 mole) of toluene diisocyanate (I) was continuously added over a period of 45 to 60 minutes, so that the resulting reaction temperature was constantly kept in a range of 130° to 135° C. Once the entire quantity of toluene diisocyanate (I) was added, the resulting reaction mixture was kept at 130° C. to 135° C. for one hour and then cooled to 80° C. Then 101.31 g (0.4147 mole) of meta-Tetramethylxylylene diisocyanate (TMXDI) (I) were added to the reactor in one shot and the resulting reaction mixture was stirred at 80° C. to 85° C. until the theoretical isocyanate-value, confirmed by titration, was reached. Typical reaction times for this step were 1 to 2 hours at temperature of 80° C. to 85° C. As soon as the theoretical isocyanate-value was confirmed by titration, a mixture of keto-functional building block (A2) of Example 1, in 9.92 g deionized water, was added to the reaction mixture in one shot and homogenized for 15 minutes at the resulting reaction temperature. Subsequently, dimethyl ethanolamine neutralizing agent (N) in 100 g deionized water was added to the reactor in one shot and homogenized for 15 minutes at the resulting reaction temperature. Then 550 g of deionized water, pre-warmed to 60° C., was added to the reactor continuously while vigorously stirring over a period of 15 minutes and the resulting emulsion was further homogenized at 60° C. for additional 30 minutes. Then the reaction mixture was cooled to a temperature of less than 40° C. and 15.31 g (0.087 mole) of adipic acid dihydrazide (B) was added and homogenized for 15 minutes. Adjustment of the solids content of the final emulsion to 40 +/-1% was done by addition of 62.42 g of deionized water. The polyurethane dispersion is characterized by a solid content of 40.1% by weight; a pH (10% aqueous solution) of 7.6; a Z-average particle size of 25 nm and a dynamic viscosity of 1802 mPa·s. The solid unneutralized polyurethane (A) is characterized by a weight average molecular weight (Mw) of 10,030 g/mole; a keto content of 368 mmole/kg; a hydroxyl content of 490 mmole/kg; and an acid content of 490 mmole/kg.

### Example 5 to 9: Synthesis of Aqueous Dispersion Comprising Carbonyl-Terminated Polyurethane A Having Pendant Acid Salt Groups and Carbonyl end-Standing Groups, and Multifunctional Compound B

In table 2 the compositions of the aqueous dispersions comprising polyurethane A having pendant acid salt groups and carbonyl end-standing groups, and multifunctional compound B are reproduced for Example 5 to 9. The aqueous dispersions of Example 5 to 9 were prepared according to the process of Example 4.

TABLE 2

| Components | Example 5 | | Example 6 | | Example 7 | | Example 8 | | Example 9 | |
|---|---|---|---|---|---|---|---|---|---|---|
| Polyester diol (ICP) | 275.21 | g | 275.21 | g | 275.21 | g | 275.21 | g | 275.21 | g |
| Neopentyl glycol (ICM) | 0.15 g | | 0.15 g | | 0.15 g | | 0.15 g | | 0.15 g | |
| | (0.0014 mole) | | (0.0014 mole) | | (0.0014 mole) | | (0.0014 mole) | | (0.0014 mole) | |
| Dimethylol propionic acid | 31.44 g | | 31.44 g | | 31.44 g | | 31.44 g | | 31.44 g | |
| (ICMA) | (0.2344 mole) | | (0.2344 mole) | | (0.2344 mole) | | (0.2344 mole) | | (0.2344 mole) | |
| Toluene diisocyanate (I) | 26.10 g | | 26.10 g | | 26.10 g | | 26.10 g | | 26.10 g | |
| | (0.1499 mole) | | (0.1499 mole) | | (0.1499 mole) | | (0.1499 mole) | | (0.1499 mole) | |
| meta-Tetramethylxylylene | 101.31 g | | 101.31 g | | 101.31 g | | 101.31 g | | 140.42 g | |
| diisocyanate (TMXDI) (1) | (0.4147 mole) | | (0.4147 mole) | | (0.4147 mole) | | (0.4147 mole) | | (0.5784 mole) | |
| Example 1 (A2) | 44.08 g | | 44.08 g | | 44.08 g | | — | | — | |
| | (0.1759 mole keto; | | (0.1759 mole keto; | | (0.1759 mole keto; | | | | | |
| | 0.2345 mole amine; | | 0.2345 mole amine; | | 0.2345 mole amine; | | | | | |
| | 0.2345 mole | | 0.2345 mole | | 0.2345 mole | | | | | |
| | hydroxyl) | | hydroxyl) | | hydroxyl) | | | | | |
| Example 3 (A2) | — | | — | | — | | 46.88 g | | 106.92 g | |
| | | | | | | | (0.1758 mole keto; | | (0.4009 mole keto; | |
| | | | | | | | 0.2344 mole amine) | | 0.5346 mole amine) | |
| Ethanolamine (A22) | — | | — | | — | | — | | — | |
| Deionized water | 9.92 | g | 9.92 | g | 9.92 | g | 9.92 | g | 22.62 | g |
| Dimethyl ethanolamine (N) | — | | — | | — | | 18.21 g | | 18.21 g | |
| | | | | | | | (0.2043 mole) | | (0.2043 mole) | |
| Triethylamine (N) | 20.67 g | | — | | — | | — | | — | |
| | (0.2043 mole) | | | | | | | | | |
| Genamin Gluco 50 (N) | — | | 86.21 g | | — | | — | | — | |
| | | | (0.2043 mole) | | | | | | | |
| Potassium hydroxide (N) | — | | — | | 12.49 g | | — | | — | |
| | | | | | (0.2227 mmole) | | | | | |
| Deionized water | 550 | g | 550 | g | 550 | g | 550 | g | 700 | g |
| Adipic acid dihydrazide (B) | 15.31 g | | 15.31 g | | 15.31 g | | 15.31 g | | 34.92 g | |
| | (0.0879 mole) | | (0.0879 mole) | | (0.0879 mole) | | (0.0879 mole) | | (0.2005 mole) | |
| Deionized water | 60.00 | g | 100.00 | g | 100.00 | g | 66.00 | g | 82.00 | g |

Testing parameters

| Solids content [% by weight] | 40.5 | 39.7 | 39.5 | 40.1 | 39.8 |
|---|---|---|---|---|---|
| pH (10% aqueous solution) | 7.4 | 7.2 | 7.4 | 7.6 | 8.2 |
| Particle size average [nm] | 33 | 28 | 26 | 41 | 129 |
| Dynamic viscosity | 4645 | 61 | 500 | 130 | 74 |
| (100 1/s; 23° C.) [mPa · s] | | | | | |

Molecular weight by GPC

| | | | | | |
|---|---|---|---|---|---|
| Mw [g/mol] | 11.290 | 9.651 | 10.610 | 10.420 | 7.690 |

Calculated values

| Keto-content of solid PU | 368 | mmole/kg | 368 | mmole/kg | 368 | mmole/kg | 365 | mmole/kg | 691 | mmole/kg |
|---|---|---|---|---|---|---|---|---|---|---|
| Keto equiv. weight of solid PU | 2717 | g/eq | 2717 | g/eq | 2717 | g/eq | 2740 | g/eq | 1447 | g/eq |
| OH-content of solid PU | 490 | mmole/kg | 490 | mmole/kg | 490 | mmole/kg | 0 | mmole/kg | 0 | mmole/kg |
| OH equiv. weight of solid PU | 2041 | g/eq | 2041 | g/eq | 2041 | g/eq | — | | — | |
| OH-value of solid PU | 27.5 | mg KOH/g | 27.5 | mg KOH/g | 27.5 | mg KOH/g | 0 | mg KOH/g | 0 mg | KOH/g |
| Acid-content of solid PU | 490 | mmole/kg | 490 | mmole/kg | 490 | mmole/kg | 487 | mmole/kg | 404 | mmole/kg |
| Acid equiv. weight of solid PU | 2041 | g/eq | 2041 | g/eq | 2041 | g/eq | 2053 | g/eq | 2475 | g/eq |

### Comparative Examples 10 to 12

In table 3 the compositions of the aqueous dispersions of comparative Examples 10 to 12 are listed, prepared according to the process of Example 4, with the exception that:
for comparative Example 10, the keto-functional building block A2 of Example 2 is added to a hydroxyl functional polyurethane prepolymer before the second polyisocyanate I addition, while primary alkanolamine A22 is added to the isocyanate terminated polyurethane A1, resulting from the second addition of polyisocyanate I to the hydroxyl functional polyurethane prepolymer; the final polyurethane is a hydroxyl terminated polyurethane comprising pendant carbonyl groups;
for comparative Example 11, there is no addition of keto-functional building block A2; only primary alkanolamine A22 is added to the isocyanate terminated polyurethane A1; the final polyurethane is a hydroxyl terminated polyurethane comprising no carbonyl groups;
for comparative Example 12, there is no addition of keto-functional building block A2; only primary alkylamine A22 is added to the isocyanate terminated polyurethane A1; the final polyurethane is a alkyl group terminated polyurethane comprising no carbonyl groups.

TABLE 3

| Components | Comp. Ex. 10 | | Comp. Ex. 11 | | Comp. Ex. 12 | |
|---|---|---|---|---|---|---|
| Polyester prepolymer (ICP) | 235.0 | g | 275.21 | g | 275.21 | g |
| Neopentyl glycol (ICM) | 0.15 g | | 0.15 g | | 0.15 g | |
| | (0.0014 mole) | | (0.0014 mole) | | (0.0014 mole) | |
| Dimethylol propionic acid (ICMA) | 31.44 g | | 31.44 g | | 31.44 g | |
| | (0.2344 mole) | | (0.2344 mole) | | (0.2344 mole) | |
| Toluene diisocyanate (1) | 22.29 g | | 26.10 g | | 26.10 g | |
| | (0.1280 mole) | | (0.1499 mole) | | (0.1499 mole) | |
| Example 2 (A2) | 40.49 g | | — | | — | |
| | (0.1752 mole keto; | | | | | |
| | 0.1776 mole amine; | | | | | |
| | 0.1776 mole hydroxyl) | | | | | |
| meta-Tetramethylxylylene | 142.43 g | | 101.31 g | | 101.31 g | |
| diisocyanate (I) | (0.5830 mole) | | (0.4147 mole) | | (0.4147 mole) | |
| Ethanolamine (A22) | 14.32 g | | 14.32 g | | — | |
| | (0.2344 mol amine; | | (0.2344 mole amine; | | | |
| | 0.2344 mole hydroxyl) | | 0.2344 mole hydroxyl) | | | |
| n-Butylamine (A22) | — | | — | | 17.13 g | |
| | | | | | (0.2344 mol amine) | |
| Deionized water | 9.92 | g | 9.92 | g | 9.92 | g |
| Dimethyl ethanolamine (N) | 18.21 g | | 18.21 g | | 18.21 g | |
| | (0.2043 mole) | | (0.2043 mole) | | (0.2043 mole) | |
| Deionized water | 100 | g | 100 | g | 100 | g |
| Deionized water | 550 | g | 500 | g | 500 | g |
| Adipic acid dihydrazide (B) | 15.31 g | | — | | — | |
| | (0.0879 mole) | | | | | |
| Deionized water | 74.08 | g | 44.67 | g | 48.78 | g |

Testing parameters

| Solids content [% by weight)] | 39.7 | 40.0 | 40.0 |
|---|---|---|---|
| pH (10% aqueous solution) | 7.5 | 7.3 | 7.8 |
| Particle size average [nm] | 28 | 30 | 357 |
| Dynamic viscosity | 5352 | 70 | 105 |
| (100 1/s; 23° C.) [mPa · s] | | | |

Molecular weight by GPC

| | | | |
|---|---|---|---|
| Mw [g/mol]; | 7.625 | 9.051 | 10.570 |

Calculated values

| Keto-content of solid PU | 360 | mmole/kg | 0 | mmole/kg | 0 | mmole/kg |
|---|---|---|---|---|---|---|
| Keto equiv. weight of solid PU | 2778 | g/eq | — | | — | |
| OH-content of solid PU | 482 | mmole/kg | 523 | mmole/kg | 0 | mmole/kg |
| OH equivalent weight of solid PU | 2075 | g/eq | 1912 | g/eq | — | |
| OH-value of solid PU | 27.0 | mg KOH/g | 29.3 | mg KOH/g | 0 | mg KOH/g |
| Acid-content of solid PU | 482 | mmole/kg | 523 | mmole/kg | 519 | mmole/kg |
| Acid equiv. weight of solid PU | 2075 | g/eq | 1912 | g/eq | 1926 | g/eq |
| Acid-value of solid PU | 27.0 | mg KOH/g | 29.3 | mg KOH/g | 29.1 | mg KOH/g |

### Coating Formulation, Coating Application, Test Results

Application tests were conducted using ABS/PC plastic panels (BAYBLEND® T65XF, Covestro AG) used in multiple applications like automotive interior and household articles. The following formulations have been prepared:

### Example 13: Preparation of Basecoat Formulations

Basecoat coating formulations were prepared from the aqueous polyurethane dispersions of Examples 4, 8 and 9 and of Comparative Examples 10, 11 and 12, according to the recipe in table 4.

TABLE 4

| | | | Amount |
|---|---|---|---|
| Step | Nr | Components (ingredients) | (parts) |
| Q | 1 | PUD binder of Ex. 4, 8, 9, Comp. Ex. 10, | 32.8 |
| | | Comp. Ex. 11 and Comp. Ex. 12 | |
| | | Dimethylethanolamine (DMEA)/10% water | 1.2 |
| | | Demi water | 8.8 |
| | 2 | Acrylic thickener (RHEOVIS ® AS 1130) | 7.1 |
| | | Silicate thickener (LAPONITE ® RD) | 11.5 |
| | | Demi water | 8.0 |
| | 3 | Metallic Pigment (STAPAR | 3.8 |
| | | IL HYDROLAN ® S 2100) | |
| | | Pigment wetting additive (ADDITOL ® XL 250) | 0.2 |
| | | Butylglycol | 5.6 |
| | 4 | Wax additive (ULTRALUBER E500V) | 6.2 |
| | 5 | i-Butanol | 1.6 |
| | 6 | Dimethylethanolamine (DMEA)/10% water | 1.0 |
| | | Demi water | 12.2 |
| | | Total | 100.0 |

A dimethyl ethanolamine solution (10% strength solution in deionized water) and deionized water (Part Q1) were added to the aqueous polyurethane dispersion of Example 4, 8, 9 and Comparative Example 10, 11, 12, and homogenized with a mechanical stirrer at 900 min-1. After fifteen minutes stirring a 10% strength solution of an acrylic copolymer thickener in deionized water (RHEOVIS®AS 1130, BASF AG), a 3% strength solution of a silicate thickener (LAPONITE® RD, BYK AG) and further deionized water (Part Q2) were added and homogenized for another 10 minutes at 900 min-1. The aluminum flake slurry (Part Q3) was prepared in a separate step by charging the aluminum flakes (silica encapsulated aluminium flakes, HYDROLAN® S-2100, Eckart GmbH), adding the anionic wetting agent (ADDITOL XL® 250, allnex GmbH) and butylglycol and homogenizing with a mechanical stirrer at 600 min⁻¹ for 30 minutes. The homogenized Part Q3 was then added with stirring at 900 min¹ to the preblended Part Q1 and Q2 and homogenized for another 20 minutes.

The Basecoats prepared in this way were allowed to rest for 12 hours at ambient temperature (23° C.). Then Part Q4 (wax additive) and Q5 was added and homogenized for another 5 minutes at 900 min⁻¹. Finally the formulation was completed with Part Q6 and homogenized for another 5 minutes at 700 min⁻¹.

### Example 14: Preparation of the Clearcoat Formulation

A two pack clearcoat composition was prepared according to the recipe in table 5.

TABLE 5

| Step | Components (ingredients) | Amount (part) |
|---|---|---|
| X | MACRYNAL ® SM 510N/65BACX (allnex) | 52.0 |
| | Butylacetate:solvent naphtha:Xylene = 60:15:25 | 8.4 |
| | Flow/leveling additive (ADDITOL ® VXL 4930N, allnex) | 0.1 |
| Y | HDI trimer isocyanate (DESMODUR ® N3390, Covestro AG) | 19.1 |
| | Butylacetate | 5.5 |
| Z | Butylacetate:solvent naphtha:Xylene = 60:15:25 | 14.9 |
| | Total | 100.0 |

The components of Part X were mixed for 15 minutes at 700 min⁻¹. Prior to application a pre-blend of a HDI trimer isocyanate crosslinker (DESMODUR® N3390, Coverstro AG) diluted in butylacetate was added (Part Y) to the mixed Part X. Finally spray application was adjusted to 21 seconds (DIN 4 cup at 23° C., DIN EN ISO 2431) with the pre-mixed solvent composition in Part Z.

### Example 15: Preparation of Test Panels

ABS/PC plastic panels comprising the basecoat of Example 13 and the clearcoat of Example 14 are represented in table 6.

The coating formulations were applied with a pneumatic spray gun (SATA RP 3000/4000/ 5000) around 1.5-2.0 bar air pressure. First, the basecoat formulations were applied at around 17 +/−2 μm dry film thickness. After application a flash off time of ten minutes followed by a baking step at 10 minutes/60° C.) was conducted to the applied basecoat formulations. Immediately after the baking step the clearcoat formulation was applied at around 40-45 μm dry film thickness. After 10 minutes flash off time all panels were cured in an oven for 30 minutes at 80° C. followed by a post-cure step for 12 hours at 70° C.

TABLE 6

| Panel | Basecoat | Clearcoat |
|---|---|---|
| 1 | Example 13 based on Example 4 | Example 14 |
| 2 | Example 13 based on Example 8 | Example 14 |
| 3 | Example 13 based on Example 9 | Example 14 |
| 4 | Example 13 based on Comp. Ex. 10 | Example 14 |
| 5 | Example 13 based on Comp. Ex. 11 | Example 14 |
| 6 | Example 13 based on Comp. Ex. 12 | Example 14 |

### Example 16: Humidity Resistance Test

Panels 1 to 6 were exposed to a humidity resistance test (hydrolysis ageing) according Volkswagen standard TL 226 done in a humidity chamber for 72 hours at 90 +/−2° C. and a relative humidity of more than 96%. Prior to the evaluation of the intercoat adhesion, the test panels were conditioned at room temperature for 4 hours after the test. Intercoat adhesion between basecoat and clearcoat was evaluated performing a cross cut test with tape pull-of (DIN EN ISO 2409) where 0 =full adhesion and 5 =complete delamination. Test results are represented in table 7.

TABLE 7

BC - CC

| Panel | Before | After |
|---|---|---|
| 1 | 1 | 0 |
| 2 | 3 | 3 |
| 3 | 3 | 2 |
| 4 | 5 | 5 |
| 5 | 5 | 5 |
| 6 | 5 | 5 |

As appears from table 7, the use of the new aqueous polyurethane dispersion, according to the present invention, as basecoat layer in a multi-layer (basecoat-clearcoat) system unexpectedly results in a significantly improved intercoat adhesion after hot water resistance tost.

1. An aqueous polyurethane dispersion comprising:
a polyurethane A having pendant acid salt groups and end-standing carbonyl groups, and
optionally a multifunctional compound B having functional groups reactable with the carbonyl groups of polyurethane A,
wherein
said polyurethane A, in its solid unneutralized form, is characterized by:
a weight average molecular weight comprised between 3,000 and 30,000 g/mol, as measured by GPC in tetrahydrofuran calibrated with polystyrene standards;
a carbonyl content of more than 150 mmole/kg; and
said polyurethane A is the reaction product of:
an isocyanate functional polyurethane prepolymer Al comprising acid groups; and
from 50 to 100 moles of a carbonyl functional building block A2, for 100 isocyanate equivalents of the isocyanate functional polyurethane prepolymer A1, said carbonyl functional building block A2 being the reaction product of an alpha, beta ethylenically unsaturated group comprising compound comprising a carbonyl group A21 and a primary amine A22, said primary amine A22 being selected from the group consisting of alkylamines, alkanol amines and mixtures thereof; and
from 0 to 50 moles of a primary amine A22, for 100 isocyanate equivalents of the isocyanate functional polyurethane prepolymer A1, said primary amine A22 being selected from the group consisting of alkylamines, alkanol amines and mixtures thereof; and
one or more acid neutralizing compound(s) N;
wherein
said carbonyl functional building block A2 comprises secondary amine groups of the formula R¹-NH-R², wherein R¹ is an alkyl or an hydroxyalkyl moiety and wherein R² is a molecular entity comprising a carbonyl group;
said carbonyl functional building block A2 is bound to the isocyanate functional polyurethane prepolymer A1 by means of an urea linkage; and
said carbonyl functional building block A2 is bound at the extremity of the isocyanate functional polyurethane prepolymer A1.

2. The aqueous polyurethane dispersion according to claim 1, wherein polyurethane A, in its solid unneutralized form, is characterized either
by a hydroxyl content of 0 mmole/kg, for R¹ being and alkyl group and optional additional alkylamine; or
by a hydroxyl content of at least 250 mmole/kg, for R¹ being an hydroxyalkyl group and optional additional alkanolamine; or
by a hydroxyl content comprised between 0 mmole/kg and at least 250 mmole/kg, for R¹ being a mixture of alkyl and hydroxyalkyl groups, and optional additional alkylamines, alkanolamines, or a mixture thereof.

3. The aqueous polyurethane dispersion according to claim 1, wherein the carbonyl groups of carbonyl functional building block A2 are of the ketone and/or aldehyde type.

4. The aqueous polyurethane dispersion according to claim 1, wherein the carbonyl functional building block A2 is the Michael addition reaction product of:
an alpha, beta ethylenically unsaturated group comprising compound comprising a carbonyl group A21, said alpha, beta ethylenically unsaturated group comprising compound comprising a carbonyl group A21 being selected from the group consisting of acrolein, methacrolein, diacetone-acrylamide, crotonaldehyde, 4-vinylbenzaldehyde, vinyl alkyl ketones of 4 to 7 carbon atoms such as vinyl methyl ketone, and acryloxy-and methacryloxy-alkyl propanols of formula CH2═CHR³—C═O—O—CHR⁴—CR⁵R⁶—C—O—H, where R³ is H or methyl, R⁴ is H or alkyl of 1 to 3 carbon atoms, R⁵ is alkyl of 1 to 3 carbon atoms, and R⁶ is alkyl of 1 to 4 carbon atoms; and
a primary amine A22 selected from the group consisting of C1-C6 alkylamines, C1-C6 alkanolamines and mixtures thereof

5. The aqueous polyurethane dispersion according to claim 1, wherein the carbonyl functional building block A2 is the Michael addition reaction product of
a primary amine A22 of the formula HO—(CH₂)n—NH₂ and/or H—(CH₂)n—NH₂, wherein n is an integer of from 1 to 6; and
diacetone acrylamide A21.

6. The aqueous polyurethane dispersion according to claim 1, wherein the isocyanate functional polyurethane prepolymer A1 is the reaction product of:
one or more polyisocyanate(s) I;
one or more isocyanate reactive compound(s) IC having at least two isocyanate reactive groups selected from the group consisting of monomeric compounds ICM, polymeric compounds ICP and mixtures thereof; and
one or more isocyanate-reactive monomer(s) ICMA having at least two isocyanate reactive groups and at least one acid group or group being able to form an acid when contacted with water;
wherein isocyanate groups of I are in stoichiometric excess of isocyanate reactive groups of IC and ICMA.

7. The aqueous polyurethane dispersion according to claim 1, wherein the multifunctional compound B is present and comprises at least two hydrazide functional groups.

8. The aqueous polyurethane dispersion according to claim 1, wherein the multifunctional compound B is present and is the reaction product of hydrazine and a polycarboxylic acid.

9. The aqueous polyurethane dispersion according to claim 1, wherein the multifunctional compound B is present and is selected from the group consisting of oxalic acid dihydrazide, malonic acid dihydrazide, succinic acid dihydrazide, glutaric acid dihydrazide, adipic acid dihydrazide cyclohexane dicarboxylic acid dihydrazide, azelaic acid dihydrazide, and sebacic acid dihydrazide.

10. The aqueous polyurethane dispersion according to claim 1, wherein the multifunctional compound B is present and is adipic acid dihydrazide.

11. The aqueous polyurethane dispersion according to claim 1, wherein the mole ratio of the carbonyl functional groups of polyurethane A to the functional groups of multifunctional compound B is from 0.7 to 1.3.

12. A method for the preparation of the aqueous polyurethane dispersions according to claim 1te 11, comprising the steps of;
a. mixing one or more polymeric compound(s) ICP having at least two isocyanate reactive groups with one or more monomer(s) ICM having at least two isocyanate reactive groups in the presence of one or more isocyanate-reactive monomers ICMA having at least two isocyanate reactive groups and an acid group or group being able to form an acid when contacted with water, and heating the mixture to a temperature of at least 60° C. for at least 10 minutes under stirring;
b. continuously adding a sub-stoichiometric quantity of one or more multifunctional isocyanate(s) I to the mixture of step a), over a time period of from ten minutes to eighty minutes while keeping the temperature in a range of from 60° C. to 150° C., to form a hydroxyl-functional polyurethane prepolymer;
c. maintaining the reaction product op step b) at a temperature comprised between 120 and 135° C. for a time period of from 30 to 90 minutes, and subsequently cooling down to a temperature comprised between 60 and 100° C.;
d. adding, in one shot, a further amount of one or more multifunctional isocyanate(s) I, in stoichiometric excess, optionally in the presence of one or more compound(s) ICM and ICMA, to the hydroxyl-functional polyurethane prepolymer of step c) while stirring at a temperature of from 60° C. to 130° C., and continuing the reaction at a temperature of from 70 to 150° C. for at least one hour, to form an isocyanate-functional polyurethane prepolymer A1 with an isocyanate value corresponding to the theoretical one;
e. adding, in one shot, a mixture of compound A2, and optionally one or more primary amine(s) A22 and optionally water, to the isocyanate-functional polyurethane prepolymer A1 of step d) standing at a temperature comprised between 70 and 95° C., and homogenizing for at least 10 minutes at the resulting temperature, to convert the isocyanate-functional polyurethane prepolymer A1 into a polyurethane comprising end-standing carbonyl groups;
f. adding, in one shot, one or more neutralizing agent(s) N, in water, to the polyurethane of step e) comprising acid groups and carbonyl groups, and homogenizing for at least 10 minutes, to convert the acid groups into the corresponding salt, resulting in polyurethane A comprising pendant acid salt groups and end-standing carbonyl groups;
g. continuously adding deionized water, pre-warmed at a temperature comprised between 50 and 70° C., to the polyurethane A of step f), while vigorously stirring during at least 10 minutes and homogenizing for a further at least 20 minutes at a temperature comprised between 50 and 70° C., to form an aqueous dispersion of polyurethane A;
h. cooling down the aqueous dispersion of polyurethane A of step g) to a temperature below 40° C. and optionally adding multifunctional compound B;
i. adding deionized water to the aqueous dispersion of step h) comprising polyurethane A and optionally multifunctional compound B, to adjust the solid content to 40 +/−1% by weight.

13. The method according to claim 12, wherein carbonyl functional building block A2, added in step e) is prepared by:
heating A21 under nitrogen, at a temperature comprised between 50 and 80° C., until entirely molten;
adding a 1 to 45 percentage molar excess of A22, in one shot; and
heating the mixture of A21 and A22 to a temperature comprised between 60 and 85° C. for a period comprised between 1 and 24 hours, until full conversion of the ethylenically unsaturated bond, as confirmed by Fourier-transform infrared spectroscopy.

14. The method according to claim 12, wherein the one or more neutralizing agent(s) N, added in step f) is (are) selected from the group consisting of primary, secondary and tertiary amines and strong Arrhenius bases such as the hydroxides of alkali metals and alkaline earth alkali metals.

15. A coating composition comprising the aqueous polyurethane dispersion according to claim 1 and one or more additives selected from the group consisting of organic solvents, defoamers, coalescing agents, flow modifiers, rheology additives, fillers, pigments, active pigments, dyes, wetting agents, emulsifiers, surfactants, thickeners, heat stabilizers, levelling agents, anti-cratering agents, sedimentation inhibitors, UV absorbers and antioxidants.

16. A coating composition according to claim 15 providing a selfcrosslinking reaction via azomethine formation during and/or after film formation.

17. A method of coating a substrate, comprising applying the coating composition according to claim 15 to the substrate, wherein the substrate is selected from the group consisting of wood, engineered wood, metal, glass, cloth, composites, concrete, ceramics, leather, paper, plastics and foam.
